(19) United States
(12) Patent Application Publication
(10) Pub. No.: US 2006/0256657 A1
(43) Pub. Date: Nov. 16, 2006

(54) Method for improving the time-depth tie of well log data and seismic data

(75) Inventor: Gary Charles Robinson, Aurora, CO (US)

Correspondence Address: DORR, CARSON & BIRNEY, P.C.;ONE CHERRY CENTER, 501 SOUTH CHERRY STREET, SUITE 800, DENVER, CO, 80246, US

(73) Assignee: Prism Seismic, Inc.

(21) Appl. No.: 11/418,756

(22) Filed: May 5, 2006

Related U.S. Application Data
(60) Provisional application No. 60/679,805, filed on May 11, 2005.

(51) Int. Cl. G01V 1/28

(52) U.S. Cl. 367/38

(57) ABSTRACT

The present methodology improves the time-depth tie between well log data and seismic data. This method refines the time-depth relationship by inverting the seismic trace at the well location, converting the trace to depth using the time-depth relationship, and then comparing the log data with the depth-converted inverted seismic trace. Depth differences between the two traces are then used to modify the time-depth relationship. The well-seismic correlation can also be modified using the revised time-depth function.

### RELATED APPLICATION

The present application is based on and claims priority to the Applicant's U.S. Provisional Patent Application 60/679,805, entitled “Method for Improving the Time-Depth Tie of Well Log Data and Seismic Data,” filed on May 11, 2005.

### BACKGROUND OF THE INVENTION

1. Field of the Invention

The present invention relates generally to the field of geophysics. More specifically, the present invention discloses a method for improving the time-depth correlation between well log data and seismic data.

2. Statement of the Problem

Time-depth correlation of well log data and seismic data is a critical step in the interpretation of seismic data, and in the use of log data in the processing of seismic data in the time domain. In the absence of checkshot information obtained in the well, correlation of the well log data and the seismic data in time is not well controlled, and is often based on a deterministic correlation of synthetic seismograms with the seismic data and/or time-depth relationships developed from other locations.

Correlating well log data, with a vertical axis in depth, to seismic data, with a vertical axis in time, is an essential process in the interpretation and analysis of seismic data. The geophysicist uses a time-depth relationship to correlate the depths of formations of interest with their corresponding times on a seismic section. This time-depth relationship can be provided by vertical seismic profiles or checkshots acquired in a well bore. A VSP or checkshot survey provides a direct measurement of the traveltime to a given depth in the well. Unfortunately, VSP or checkshot surveys are not acquired in all wells.

In wells without VSP or checkshot surveys, the time-depth relationship used to correlate well data with seismic data may be derived from several sources: integration of the sonic log traveltime measurements, empirical velocity (time-depth) functions, seismic velocities, and time-depth functions from other wells. Once a time-depth function has been established, the impedance log (1000000*density log/sonic log) can be converted to time and a reflection coefficient series can be calculated. This reflection coefficient series is then convolved with an appropriate seismic wavelet and compared to the seismic trace data recorded at (or near) the well location. Often the time-depth relationship must be modified in order to improve the correlation between the seismic trace and the synthetic trace, as various factors, such as dispersion, anisotropy, formation damage or invasion, borehole washouts, and cycle skips, cause the sonic log velocities to differ from the seismic wave velocities.

This modification of the time-depth relationship to improve the correlation between the synthetic trace and the seismic trace is typically an empirical process. The geophysicist selects a point on the synthetic trace and what is deemed to be a corresponding point on the seismic trace, and the time-depth relationship is modified in order to match the two points in time (at the seismic trace time). As this method of refining the time-depth relationship can introduce errors arising from visual correlations that improve the correlation of the synthetic and seismic trace that are geologically incorrect, there is a need for a method to refine the time-depth relationship that is not based upon geologic, not empirical, correlations.

3. Solution to the Problem

The present invention addresses the shortcomings of the prior art by providing an improved method for refining the time-depth tie. In particular, this method refines the deterministic time-depth relationship by inverting the seismic trace at the well location, converting the trace to depth using the time-depth relationship, and then comparing the log data in depth with the depth-converted inverted seismic trace. Depth differences between the two traces are used to modify the time-depth relationship so that depths on the depth-converted impedance trace match the depths of the log data.

### SUMMARY OF THE INVENTION

This invention provides a method for improving the time-depth tie between well log data and seismic data. This method refines the time-depth relationship by inverting the seismic trace at the well location, converting the trace to depth using the time-depth relationship, and then comparing the log data with the depth-converted inverted seismic trace. Depth differences between the two traces are then used to modify the time-depth relationship. The well-seismic correlation can also be modified using the revised time-depth function.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a diagram showing the parameters involved in the refinement of the time-depth relationship for a layer.

FIG. 2 is a schematic diagram of the correlation process between a well impedance log 10 and an inverted seismic impedance trace 20.

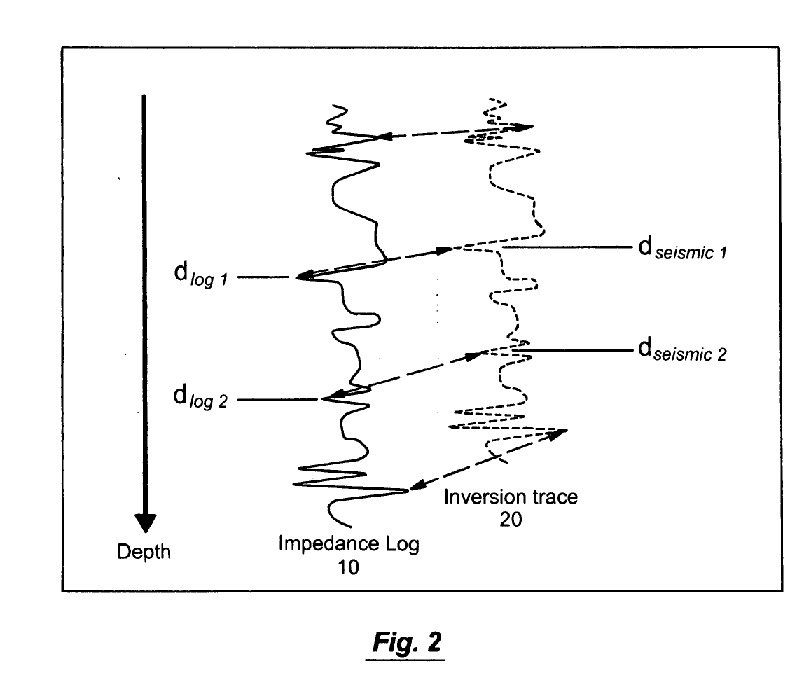

FIG. 3 is a flowchart of one embodiment of the present methodology.

FIG. 4 is a diagram showing an example of an initial well-seismic calibration.

FIG. 5 is a diagram showing an example of the well impedance log 10 and seismic impedance trace 20 used to derive correlation points.

FIG. 6 is a diagram corresponding to FIG. 4 showing well-seismic correlation after application of the revised time-depth function.

### DETAILED DESCRIPTION OF THE INVENTION

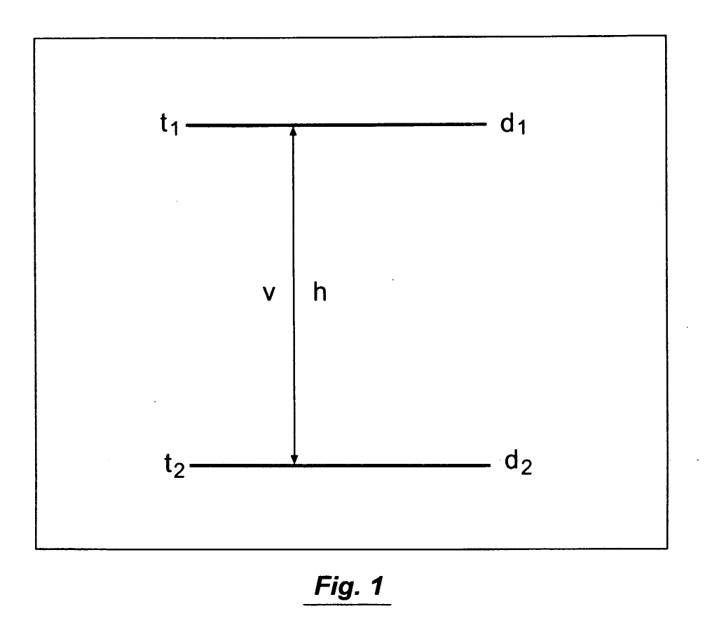

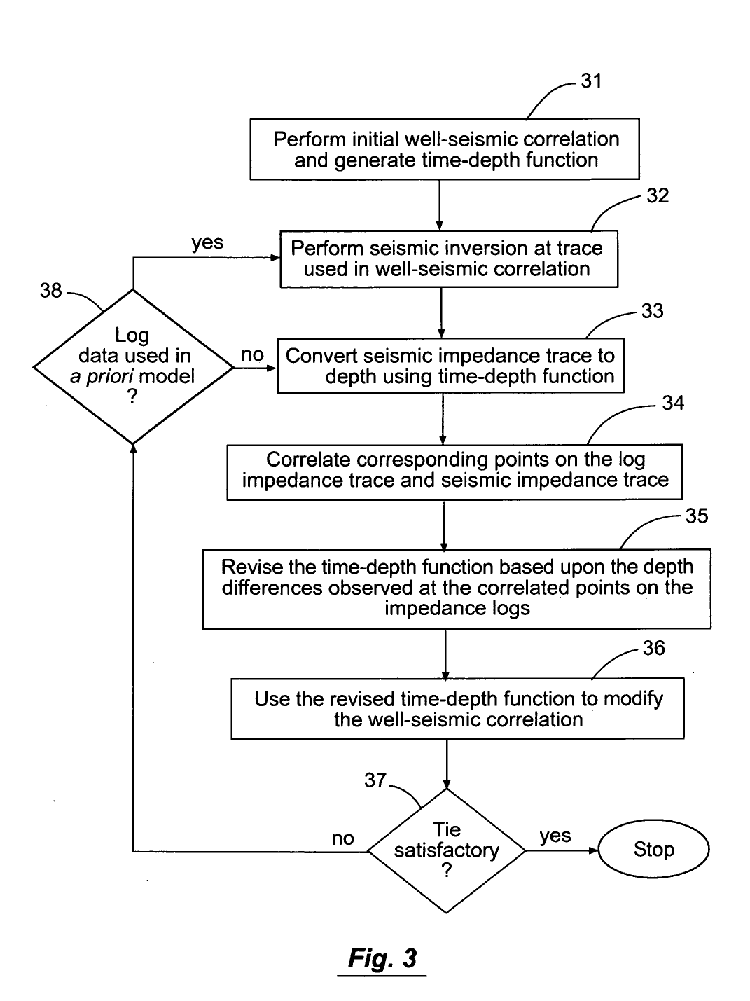

Turning to FIG. 3, a flow chart is provided illustrating the steps in one embodiment of the present invention. A synthetic seismogram is generated using a time-depth relationship derived from any one or combination of sources. The time-depth function may be refined using the empirical process described above (correlating points on the synthetic trace and seismic trace) or any other refinement process. In order to further refine the time-depth relationship, the acoustic impedance log in depth (computed from the product of the velocity log and density log in the well) can be initially correlated with the seismic trace (step 31). FIG. 1 shows an example of an initial well-seismic calibration with a correlation coefficient calculated between 1300 and 1480 ms of 0.221.

The seismic acoustic impedance trace (in time) is obtained from the seismic trace by performing an inversion on the seismic trace to generate an acoustic impedance values (step 32). Seismic impedance inversion is a procedure that derives an acoustic impedance time series from an input seismic trace. The seismic impedance inversion may be performed using any one of the various available inversion methods, such as recursive inversion (Becquey, M., Layergne, M. and Willm, C., 1979, Acoustic Impedance Logs Computed From Seismic Traces: Geophysics, Soc. of Expl. Geophys., 44, 1485-1501), generalized linear inversion (Cooke, D. A. and Schneider, W. A., 1983, Generalized Linear Inversion Of Reflection Seismic Data: Geophysics, Soc. of Expl. Geophys., 48, 665-676), sparse spike inversion (Oldenburg, D. W., Scheuer, T. and Levy, S., 1983, Recovery Of The Acoustic Impedance From Reflection Seismograms: Geophysics, Soc. of Expl. Geophys., 48, 1318-1337; Walker, C. and Ulrych, T. J., 1983, Autoregressive Recovery Of The Acoustic Impedance: Geophysics, Soc. of Expl. Geophys., 48, 1338-1350), integration of the seismic trace (Berteussen, K. A. and Ursin, B., 1983, Approximate Computation Of The Acoustic Impedance From Seismic Data: Geophysics, Soc. of Expl. Geophys., 48, 1351-1358), stochastic inversion (Haas, A. and Dubrule, O., 1994, Geostatistical Inversion—A Sequential Method Of Stochastic Reservoir Modelling Constrained By Seismic Data: First Break, 12, no. 11, 561-569), neural network inversion (Liu, Z. and Liu, J., 1998, Seismic-Controlled Nonlinear Extrapolation Of Well Parameters Using Neural Networks: Geophysics, Soc. of Expl. Geophys., 63, 2035-2041), or hybrid inversion techniques (Fu, L. Y., 2004, Joint Inversion Of Seismic Data For Acoustic Impedance: Geophysics, Soc. of Expl. Geophys., 69, 994-1004). All of these articles are incorporated herein by reference.

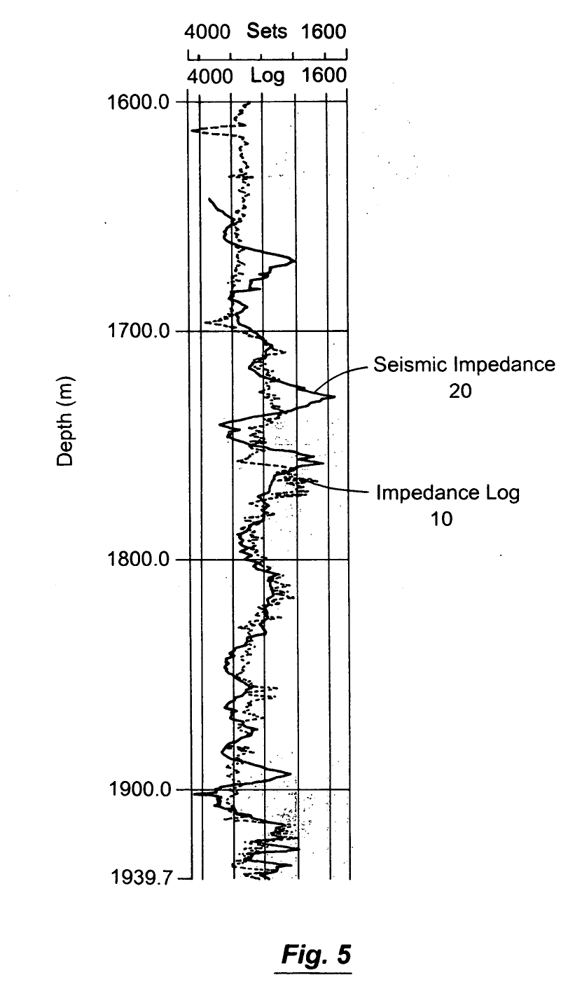

Using the initial time-depth relationship, the seismic acoustic impedance trace 20 generated by inversion of the seismic trace is then converted to depth (step 33) and compared with the acoustic impedance log 10 at the well. The user then correlates corresponding points on the well acoustic impedance log 10 and the seismic impedance trace 20 generated by inversion, as shown for example in FIG. 5 (step 34). If the time-depth relationship is correct, these corresponding points will occur at identical depths. Errors in the time-depth relationship will be manifest as differences in the depths of corresponding points. Velocities that are slower than the actual velocity will produce depth intervals on the seismic impedance trace 20 that are thinner than expected. Conversely, velocities that are faster than the actual velocity will produce depth intervals on the seismic impedance trace 20 that are thicker than expected.

The time-depth function can then be revised based on the depth differences observed at the correlated point in the impedance log 10 and inversion trace 20 (step 35). FIG. 1 displays the parameters involved in the refinement of the time-depth relationship for one layer. The relation between the parameters is given by the following equations:
d₁+(t₂−t₁)*v=d₂
h=(t₂−t₁)*v
d₁+h=d₂
t₁+h/v=t
where
t₁=time of upper interface (one-way traveltime)
t₂=time of lower interface (one-way traveltime)
d₁=depth of upper interface
d₂=depth of lower interface
v=interval velocity
h=interval thickness

Once the seismic impedance trace has been converted to depth in step 33, the thicknesses (h) of the intervals on the seismic impedance trace are compared to the true thicknesses of the intervals on the well impedance logs in step 34. Errors in the thickness of an interval are linearly related to errors in the interval velocity through the following equations:
hₑᵣᵣₒᵣ=hₜᵣᵤₑ−h_{seismic}=(d₂ₜᵣᵤₑ−d₁ₜᵣᵤₑ)−[d₁ₜᵣᵤₑ+(t₂ₜᵣᵤₑ−t₁ₜᵣᵤₑ)*v]
hₑᵣᵣₒᵣ=d₁ₜᵣᵤₑ+(t₂ₜᵣᵤₑ−t₁ₜᵣᵤₑ)*(vₜᵣᵤₑ+vₑᵣᵣₒᵣ)
hₑᵣᵣₒᵣ=vₑᵣᵣₒᵣ*(t₂ₜᵣᵤₑ−t₁ₜᵣᵤₑ)+[d₁ₜᵣᵤₑ+vₜᵣᵤₑ*(t₂ₜᵣᵤₑ−t₁ₜᵣᵤₑ)]
By rearranging terms, the velocity error is given by the following equation:

$${v}_{error} = \frac{{h}_{error} - [ {d}_{1 true} + {v}_{true} * ( {t}_{2 true} - {t}_{1 true} ) ]}{{t}_{2 true} - {t}_{1 true}}$$

For a given time-depth table, typically generated by integrating the traveltimes measured by a well sonic log, an updated time-depth relationship can be generated by modifying the depth values using the following equation (step 35):

$${d}_{t\_ corrected} = {d}_{seismic 1} + ( {d}_{t} - {d}_{log 1} ) * \frac{{d}_{seismic 2} - {d}_{seismic 1}}{{d}_{log 2} - {d}_{log 1}}$$

where
dₜ_{_{—}}_{corrected}=corrected depth at time t
dₜ=uncorrected depth at time t
d_{seismic1}=depth from the inversion result at the start of the interval
d_{seismic2}=depth from the inversion result at the end of the interval
d_{log1}=depth from the impedance log at the start of the interval
d_{log2}=depth from the impedance log at the end of the interval
   For intervals above first correlation point of the log data or below the last correlation point of the log data, the equation becomes:
   dₜ_{_{—}}_{corrected}=d_{FirstCorrelationPoint}_{_{—}}_{corrected}+(dₜ−d_{FirstCorrelationPoint}_{_{—}}_{corrected})
   for depths above the first impedance log correlation point and
   dₜ_{_{—}}_{corrected}=d_{LastCorrelationPoint}_{_{—}}_{corrected}+(dₜ−d_{LastCorrelationPoint}_{_{—}}_{corrected})
   for depths below the last impedance log correlation point.

The revised time-depth function is then used to modify the well-seismic correlation (step 36). Modifying the depth, rather than the time, is preferable as the time-depth table is most often sampled linearly in time, and thus modifying the time values would require an additional step of regularizing the time-depth pairs to a uniform time sampling interval.

The correlation between the inverted seismic impedance trace 20 and the log impedance trace 10 in depth can be used to generate pseudo-checkshots at discrete tie points, or it can be used to modify the time-depth table itself. In both cases, the original depths from the log impedance trace at a specified time are replaced with the correlative depths on the seismic impedance trace.

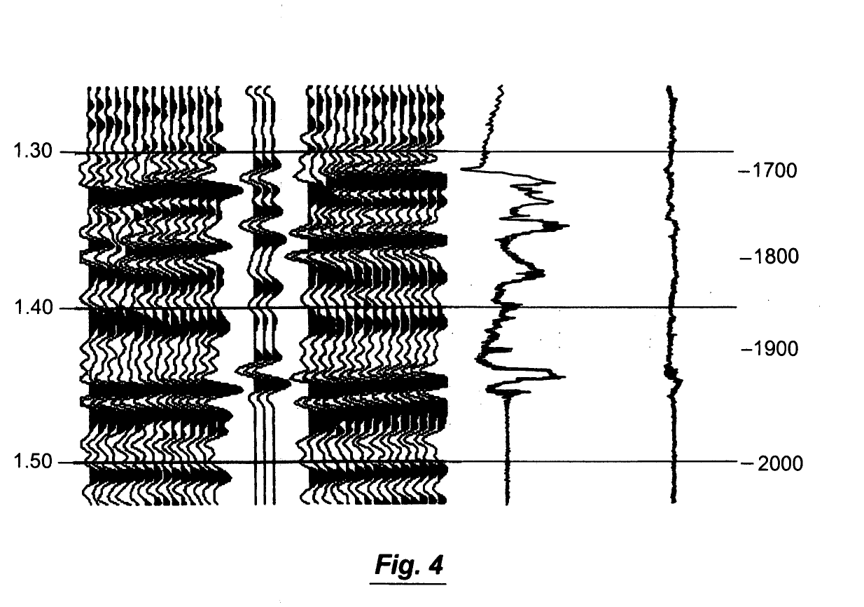

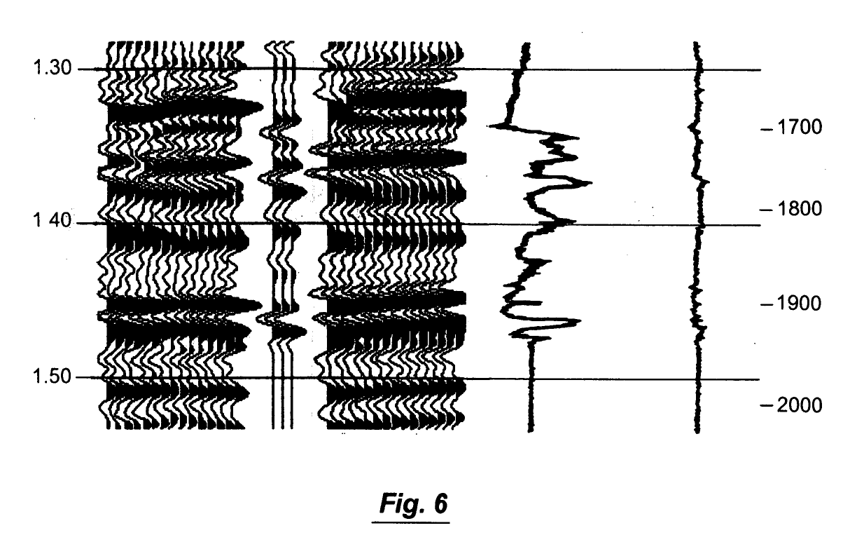

If the resulting depth differences observed for correlated points are within desired tolerances indicating a satisfactory tie between the well log data and seismic data (step 37), the process stops. Otherwise, the process loops to step 38 as shown in FIG. 3. If the well log data was used in an a priori model in the previous inversion of the seismic data, the process returns to step 32. If not, the process returns to step 33. For example, FIG. 6 shows a well-seismic correlation corresponding to FIG. 4 after application of revised time-depth function. The correlation coefficient is 0.421, which is nearly double the initial value in FIG. 4.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A method for improving the time-depth tie between a well log and seismic data, said method comprising:
inverting the seismic data to obtain a seismic impedance trace in the time domain using an initial time-depth function;
converting the seismic impedance trace in the time domain to a function of depth using the initial time-depth function;
comparing the well log with the converted seismic impedance trace in depth; and
revising the time-depth function based on depth differences between the well log and the converted seismic impedance trace.

2. The method of claim 1 wherein the initial time-depth function is generated by an initial correlation between the well log and seismic data.

3. The method of claim 2 further comprising the subsequent step of modifying the correlation between the well log and seismic data using the revised time-depth function.

4. The method of claim 1 wherein the step of comparing the well log with the converted seismic impedance trace is performed by correlating points between the well log and converted seismic impedance trace.

5. A method for improving the time-depth tie between a well log and seismic data, said method comprising:
performing an initial correlation between a well log and seismic data;
generating an initial time-depth function;
inverting the seismic data to obtain a seismic impedance trace in the time domain;
converting the seismic impedance trace in the time domain to a function of depth using the initial time-depth function;
correlating corresponding points on the well log and the converted seismic impedance trace;
revising the time-depth function based on depth differences for the correlated points; and
revising the correlation between the well log and seismic data using the revised time-depth function.

6. The method of claim 5 further comprising the subsequent step of evaluating whether the revised correlation between the well log and seismic data provides a satisfactory time-depth tie, and if not, returning to the step of converting the seismic impedance trace in the time domain to a function of depth using the revised time-depth function.

7. A method for improving the time-depth tie between a well log and seismic data, said method comprising:
(a) performing an initial correlation between a well log and seismic data;
(b) generating an initial time-depth function;
(c) inverting the seismic data to obtain a seismic impedance trace in the time domain;
(d) converting the seismic impedance trace in the time domain to a function of depth using the initial time-depth function;
(e) correlating corresponding points on the well log and the converted seismic impedance trace;
(f) revising the time-depth function based on depth differences for the correlated points;
(g) revising the correlation between the well log and seismic data using the revised time-depth function; and
(h) evaluating whether the revised correlation between the well log and seismic data provides a satisfactory time-depth tie, and if not, either: (i) returning to step (c) to invert the seismic data using the revised time-depth function if well log data was used in inverting the seismic data; or (ii) returning to step (d) to convert the seismic impedance trace to a function of depth using the revised time-depth function if well log data was not used in inverting the seismic data.
